(19) United States
(12) Patent Application Publication
(10) Pub. No.: US 2016/0086121 A1
(43) Pub. Date: Mar. 24, 2016

(54) Providing Gamification Analytics in an Enterprise Environment

(71) Applicants: Benjamin Heilbrunn, Dresden (DE); Philipp Herzig, Berlin (DE)

(72) Inventors: Benjamin Heilbrunn, Dresden (DE); Philipp Herzig, Berlin (DE)

(21) Appl. No.: 14/491,826

(22) Filed: Sep. 19, 2014

(51) Int. Cl. G06Q 10/06

(52) U.S. Cl. CPC G06Q 10/06393

(57) ABSTRACT

Technical solutions for Systems and methods for providing gamification analytics in an enterprise environment are provided. In some implementations, a method includes: analyzing performance of an enterprise data processing application that has been gamified in accordance with a predefined gamification design, by: obtaining gamification data associated with the enterprise data processing application; analyzing the gamification data in accordance with a modeled set of performance criteria; evaluating the predefined gamification design in accordance with the gamification data, thereby generating a predefined number of performance indices; and visualizing the predefined number of performance indices for a user. The predefined gamification design specifies one or more gamification rules.

### BACKGROUND

Gamification is an evolving technique by which gamification mechanics are applied to non-gaming applications in order to increase user engagement, motivation, and participation. This approach is especially promising in the enterprise domain (e.g., such as in an ERP application) since enterprise information systems (EIS) focus mainly on efficiency aspects rather than individual long-term motivation or enjoyment. Studies have shown that these latter variables lead to higher positive organizational outcomes, e.g., job performance. Initial gamification attempts have been successfully implemented and show promise.

Difficulties abound, however. One technical problem is that, existing gamification platforms are designed for business-to-end-users—rather than for process or performance improvement within a business organization itself. There is thus a need for applying gamification system in an enterprise environment, e.g., within the enterprise planning/management context.

Another technical problem is the lack of an effective and efficient way for analyzing application data and gamification data in an enterprise environment, once they are collected by a gamification platform. For example, a single user action (e.g., updating an employee's HR record) within an enterprise application system can trigger hundreds of events (e.g., recording a timely record update by an HR professional, recording a change to the employee's profile, and recording a successful user access to a remote database), and gathering and correlating these events may be both time- and resource-consuming.

A third technical problem is that, without an adequate analysis of the collected gamification data, adapting or improving existing gamification designs may be difficult. For example, without a thorough understanding of which factors motivate an employee to keep track of his/her current workload (which may be derived from an analysis of the employee's behavior data), a gamification expert cannot effectively make better an existing gamification design.

There is therefore a need for improved techniques to provide gamification analytics.

### BRIEF DESCRIPTION OF THE DRAWINGS

FIG. 1 is an example block diagram illustrating a computing system for providing gamification analytics in an enterprise environment, in accordance with some implementations;

FIG. 2 is a diagram that illustrates software components and data storages. It shows software interfaces between components, and dataflows between components and data storages.

FIGS. 3A-3C are example flow charts illustrating various methods for providing gamification analytics in an enterprise environment, in accordance with some implementations;

FIG. 4 is an example flow chart illustrating various methods for providing gamification analytics in an enterprise environment, in accordance with some implementations;

FIGS. 5-10 are example screen images illustrating various user interfaces for providing gamification analytics in an enterprise environment, in accordance with some implementations; and

FIG. 11 is an example block diagram illustrating an example computing system for providing gamification analytics in an enterprise environment, in accordance with some implementations.

### DETAILED DESCRIPTION

The implementations described herein provide various technical solutions to improve performance of an enterprise data processing application that have been gamified according to a predefined gamification design, and in particular to the above-identified technical problems—by providing, to a user (e.g., a gamification expert), analytics relating to key performance indicator concerning the gamified enterprise data processing application.

For reasons explained above, the application of gamification techniques to enterprise data processing applications (such as an enterprise resource planning (ERP) application, an enterprise data management (EDM) application, or an enterprise feedback management (EFM)) has proven effective. Adapting or improving an existing gamification design (so as to improve performance of a gamified software application), however, may require meaningful analytics of gamification data. This may be particularly difficult when involved is an enterprise data processing application, where gamification data are often more complex in nature and larger in size.

Therefore, it may be advantageous to provide an analytics tool for: analyzing event data collected from one or more gamified enterprise applications, in accordance with one or more performance criteria; and enabling a gamification expert to adopt (or improve) a gamification design in accordance with the analysis.

As a non-limiting example, using one or more user-selected key performance indicators (KPIs), a gamification analytics application monitors, periodically or randomly, (1) the status of a gamified enterprise data processing application, e.g., how timely and frequently software programmers (at various corporate locations) adhere to a corporate-wide code version control policy, the timing of each code check-in/check-out; and (2) user attributes (e.g., user characteristics): such as, to which offices or geographical locations (e.g., the UK or the US) these users belong, their team assignments and titles (e.g., a programmer, a project manager, a team leader, or a testing engineer), and employment statuses (e.g., a full time employee or an independent contractor).

Next, these KPIs and user attributes are then analyzed to determine whether the current gamification design is effective or meets expectations. To continue with the above example, under the current gamification design, a first group of employees is given an “on-time” badge” for every 50 timely code check-ins, but a different group of similarly-situated employees (e.g., same job title, same salary, and same work location) is awarded a free lunch for the same efforts. After monitoring 100 enterprise application users, the analytics application finds that the first group reported 10 times more timely code check-ins than the second group. Using these data, a gamification expert may conclude that offering the “on-time” badge is more effective to promote adherence to corporate code management policy, and may in turn modify the current gamification design in accordance with these conclusions.

By these ways, meaningful analytics of gamification data associated with a (gamified) enterprise data processing application are provided; and performance of the enterprise data processing application and existing gamification techniques can therefore be improved.

Additional details of implementations are now described in relation to the figures.

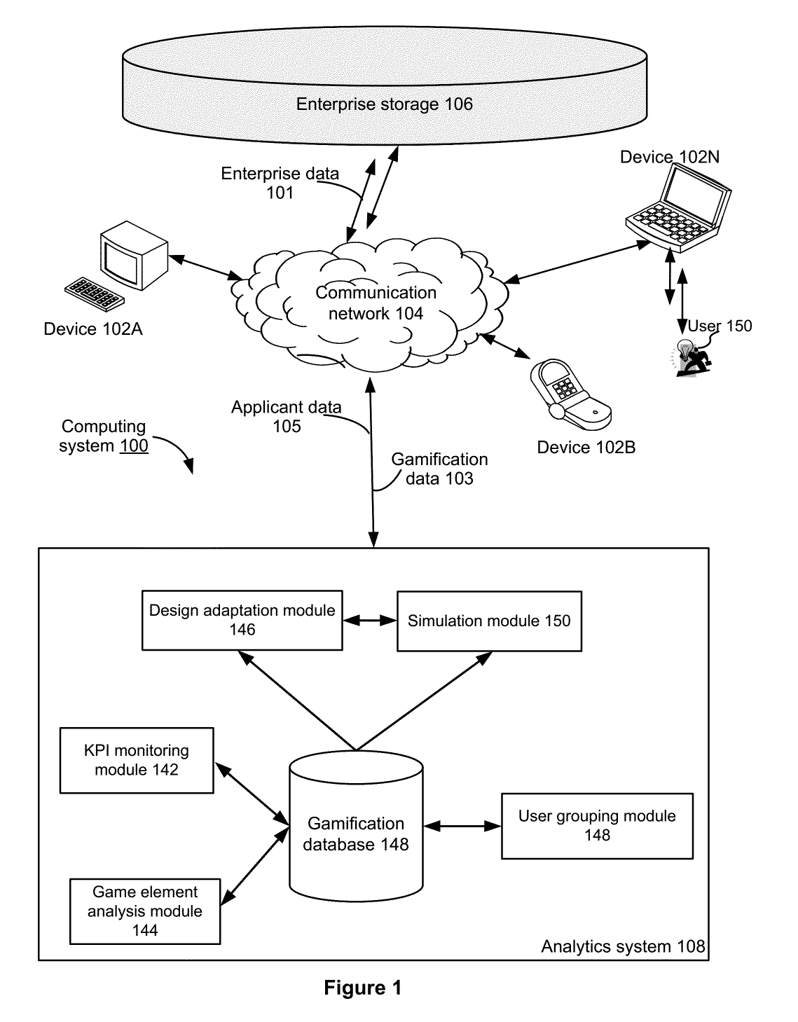

FIG. 1 is an example block diagram illustrating a computing system for providing gamification analytics in an enterprise environment, in accordance with some implementations.

In some implementations, the computing system 100 includes one or more computing devices 102 (e.g., 102-A, 102-B, . . . , and 102-N), a communication network 104, an enterprise storage 106, and an analytics system 108.

In some implementations, a computing device 102 enables a user to interact one or more enterprise data processing applications, such as an enterprise resource planning (ERP) application, an enterprise data management (EDM) application, or an enterprise feedback management (EFM). In some implementations, the computing device 102 obtains enterprise data 101 from appropriate data sources (e.g., the enterprise storage 106), processes these data, and displays them (or a portion thereof) to a user 150. In some implementations, the computing device 102 is a mobile computing device, such as a laptop computer, a notebook computer, a smartphone, or a tablet computer.

In some implementations, the communication network 104 interconnects one or more computing devices 102 with each other, and with the enterprise storage 106. In some implementations, the communication network 104 optionally includes the Internet, one or more local area networks (LANs), one or more wide area networks (WANs), other types of networks, or a combination of such networks.

In some implementations, the enterprise storage 106 stores and manages the enterprise data 101, e.g., for user consumption at a computing device 102. In some implementations, the enterprise data include business data, such as sales/expenses/revenues, customer profiles, and supplier profiles. In some implementations, the enterprise storage 106 includes one or more databases, for example, a MICROSOFT SQL Server database, an Oracle database, or a SYBASE database.

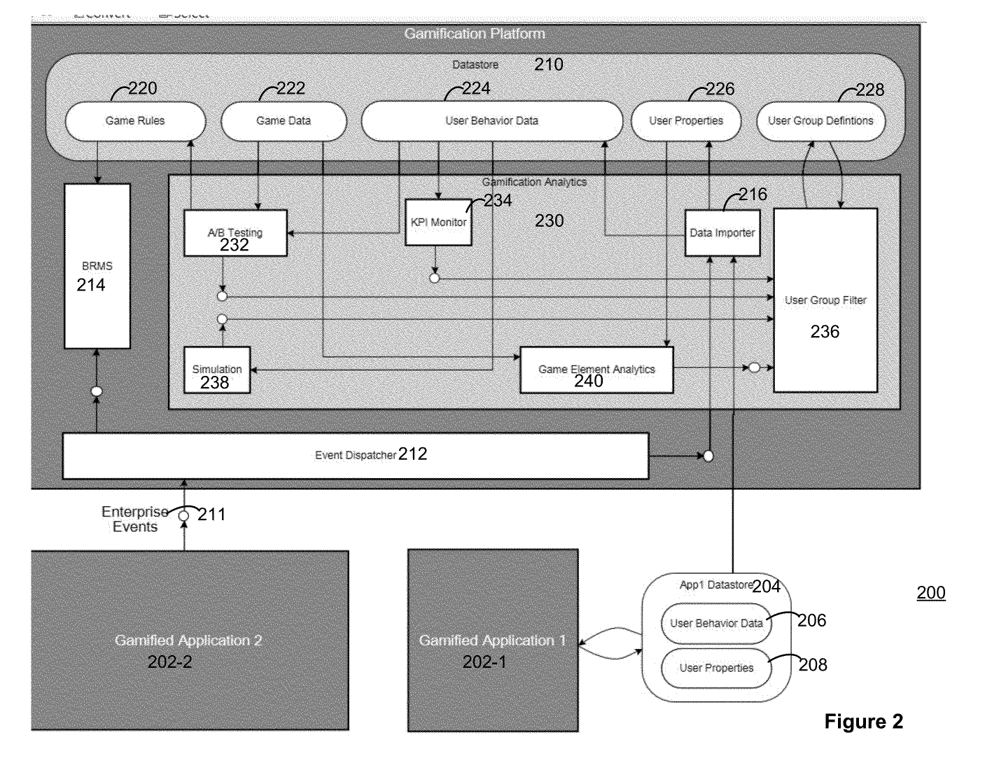

In some implementations, the analytics system 108 analyzes various different types of data (or metadata, e.g., timestamps) collected from an enterprise data processing system, such as which users (and their corresponding work locations) have reached a predefined gamification level (e.g., adherence to a corporate's code check-in policy 70% of the time), and presents these analysis results to a user, e.g., a gamification expert. In some implementations, the data (or metadata, e.g., timestamps) collected from the enterprise data processing system is stored in a gamification platform (e.g., the gamification platform 210 shown in FIG. 2), which is separate and independent form the analytics system 108, for example, the gamification platform and the analytics system are provided by different providers (e.g., vendors). In some implementations, the gamification platform is designed as a layer (e.g., as software packages or hardware components) between the communication network 104 and analytics system 108. In some implementations, the gamification platform “translates” (e.g., interprets or analyzes) application data 105 into gamification data 103.

In some implementations, the analytics system 108 includes a KPI monitoring module 142, a gamification element analysis module 144, a design adaptation module 146, a simulation module 150, and a user grouping module 148.

In some implementations, the KPI monitoring module 142 monitors (e.g., randomly, on a predefined schedule, or substantially contemporaneously) or calculates one or more application KPIs (e.g., total number of new blog posts per user per month in an online help community), which can be interpreted by a gamification expert to measure a degree of success of a gamification design (e.g., whether a current gamification design achieves 9 out of the 10 original goals).

In some implementations, the monitored application KPIs include customized KPIs, pattern based KPIs. In some implementations, a gamification expert sets one or more goal values for a monitored KPI, and is alert to the fulfillments thereof.

In some implementations, a customized KPI is defined by a user (e.g., a gamification expert or an IT expert) using customized formulas. For example, to measure how engaged user in an online community is, a gamification expert can define a new blog per user per hour to measure how active the online users are in terms of exchanging information among themselves. In some implementations, the customized KPIs include domain specific KPIs (e.g., KPIs specified to enterprise applications), which are defined by a gamification expert using application log data, such as event stream, database, and log files. In some implementations, a customized KPI is revised (e.g., re-customized) during an evaluation process, so that a gamification expert can switch from monitoring one set of KPIs to another set without re-start the evaluation process.

In some implementations, a pattern based KPI is defined (e.g., by a gamification expert) so as to count the number of occurrences of a particular pattern: e.g., the number of times a programmer checks in code changes 5 minutes after receiving an email reminder; and a percentage of users, within an online community, who reads community rules before posting their first questions.

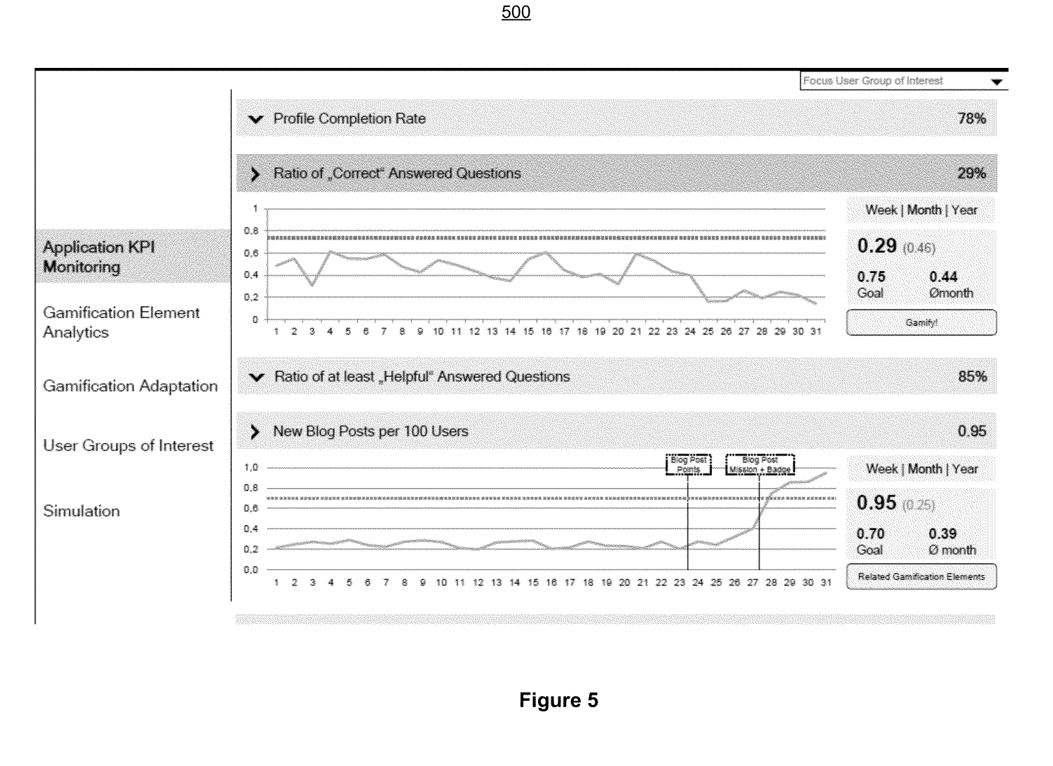

In some implementations, a KPI goal value is defined by a gamification expert. In some implementations, fulfillments of a KPI goal value are automatically monitored, without user invention, by the analytics system 108. For example, every time a specific criterion (e.g., new blog post per user per day is more than 0.7) is met, a corresponding event (e.g., such as a goal fulfillment) is recorded (as shown in FIG. 5), which can then be evaluated by a gamification expert.

In some implementations, KPIs are defined upon historical event data. For example, a gamification expert viewing gamification data previously collected can define KPIs for these past gamification data and analyze these past gamification data in accordance with these KPIs. These techniques are advantageous because they not only provide new perspectives during a data exploration process, but also assist gamification experts in interpreting past enterprise events that took place without a gamification design. In some implementations, an enterprise event is defined as an event that occurs in an enterprise data processing application, such as a software engineer checks in a set of code changes using an enterprise code version control system, and an HR professional updates an employee's profile in a human resource management system.

In some implementations, the gamification element analysis module 144 analyzes data relating to one or more gamification states or gamification elements, e.g., in accordance with time or user distribution, and visualizes these data (e.g., using a bar chart, a pie chart, or a table) for review by a gamification expert. For example, if a group of users spent a more than significant amount of time than expected finishing an assigned task, a gamification expert may conclude that the task is more complex than expected, and that therefore time and/or rewards originally allocated for completing this task should be increased, so as to encourage compliance to corporate policies. For another example, if a group of users reached a predefined gamification level (e.g., 50% compliance with a corporate time-off reporting policy) much faster than expected, it may be concluded that a higher standard (e.g., 90% compliance) may now be required or that rewards for compliance may be reduced (e.g., from monthly free lunch to positive factor in an HR report). Analyzing gamification elements (or states) is advantageous, as it provides a gamification expert (1) an over view of gamification states and their progression/developments over time, and (2) a relationship between gamification states and user distributions therein (e.g., a correlation between user properties and gamification state of those users), enabling the gamification expert to discover potential gamification design imperfections or flaws.

In some implementations, the gamification elements include gamification feedback rate. In some implementations, gamification feedback is defined as a state change in a gamification (e.g., a gamified enterprise application) that is perceived by a user as success, e.g., gaining points, reaching a new gamification level, or receiving a badge. In some implementations, correspondingly, the gamification feedback rate is defined as the amount of feedback received from a user (or a group of users) over a predefined time period (e.g., the total amount of time the user spent interaction with the gamified enterprise application).

In some implementations, the gamification element analysis module 144 provides feedback rate, corresponding descriptive statistics, and annotations representing one or more past gamification design changes. This information, in some cases, helps a gamification expert to spot and investigate unexpected user behaviors. For example, a gamification with an average of 0.1 feedbacks per user hour and a maximum of 20 feedbacks per user hour might have design flaws, because users on average perform quite poorly in view of the required standards. In this case, lower standard may be imposed or reward increased to retain user and to encourage compliance. For example, a design change that provides a free training session to users who achieve 30% compliance (instead of 100% compliance) with code check-in policies may be implemented. In some cases, the above data can also be interpreted, by a gamification expert, as meaning that this particular group of users is not well addressed (e.g., encouraged) by existing gamification rules, which resulted the big min-max interval. In some cases, a gamification expert may revise existing gamification rules to better address the behavior of this particular group of users.

In some implementations, the gamification elements include point distributions, e.g., among a group of users. In some implementations, point distributions are visualized. In some implementations, corresponding descriptive analysis is also provided. This is advantageous, as an (e.g., grossly) imbalanced point distribution for gamified actions may indicate potential gamification design defects or flaws. For example, if, after a predefined time period, 1% of all participated gamification users own 90% of the total number of points distributed, a gamification expert may discover that some users have taken an unexpected advantage through a rule loophole, and may now revise the gamification design accordingly. For example, a rule specifying that any user completing any one of a predetermined set of IT task is awarded 100 points may lead to 90% of the total points given out to IT staff in a law firm, due to the reason that only IT staff have the appropriate access for accomplishing these IT tasks (e.g., updating database log, change work station login password, or database backup), a gamification expert may revise the gamification rules, e.g., to include (e.g., HR, administrative, or maintenance) tasks that users in other departments also have access to.

In some implementations, the gamification elements include achievable gamification elements, such as badges, levels, missions, and rewards. Analytics relating to these achievable gamification elements includes, for example, how many users have received 5 badges (or a particular type of badge), how soon on average a group of users complete a mission, the percentage of users who have reached the final gamification level.

In some implementations, the gamification element analytics include user distribution on particular gamification element states. In some implementations, for gamified applications that involve (or can be described as involving) missions (e.g., a series of tasks), gamification element states include: mission completed, mission active, and not assigned to mission. These techniques enable a user (e.g., a gamification expert) to understand how other users (e.g., gamification participants) progress in terms of different gamification elements. For example, using an analysis of user distributions over several gamification missions (or application tasks), which shows that only a handful of users have completed a particular mission, while most others are stuck in a particular sub-goal of that mission, a gamification expert may concluded that the design of that mission needs to be adjusted so as to allow greater user participation (e.g., enabling the majority of the users to advance to the final stage).

In some implementations, the analysis of gamification elements are provided to a user (e.g., a gamification expert) by means of temporal statistics, a statistics on e.g., how long a group of users needed to complete a particular gamification element. In some implementations, the temporal statistics include: (1) time to completion, e.g., the time period between a user begins and completes a gamification element; (2) time to assignment, e.g., the time period between a user joins a gamification (or a gamified enterprise application) and the user is assigned a gamification element (e.g., a task); (3) time active, e.g., the time period between a task assignment and the completion thereof. These techniques are advantageous as they enable a gamification expert to view gamification data and application data from a particular perspective. For example, after noticing that a group of users, on many past occasions, completed a mission significantly faster than expected, a gamification expert may conclude that the mission needed to be revised to include more tasks, in order to keep user interested.

In some implementations, the gamification element analytics include user characteristics (e.g., user attributes). In some implementations, a gamification expert (or a gamification expert) reviews attributes associated with a group of users (e.g., who have been awarded “a timely reporter” badge) at the same gamification stage (e.g., 60% compliance with a time-off reporting policy), to discern statistically significant properties the group of users (or a predefined percentage thereof) share in common. In some implementations, the gamification elements include gamification properties. In some implementations, a gamification property corresponds to a user's state in a game, e.g., owning a badge or receiving a reward, while a user property corresponds to information (provided by the game) about the user, e.g., from geographical region Europe. Correlating gamification properties with one or more user properties, in some cases, can reveal factors effecting user engagement in context of a particular gamification element; and a gamification expert can therefore customize gamification designs for their particular group of audience. For example, if a mission (e.g., adhering to EP programming naming conventions) is significantly more often completed by one group of users (e.g., European engineers) than by another group of users (e.g., American engineers), a gamification expert can revise gamification design to accommodate other groups of users and therefore encourage their participation—thereby promoting enterprise efficiency.

In some implementations, a drill-down functionality is provided with respect to each individual gamification element, e.g., so as to enable a more in-depth investigation of a particular gamification elements. In some implementations, the drill-down functionality is implemented using a dashboard view, which shows completion rates and temporal statistics of gamification elements. As an example, a gamification design might require adaptation (e.g., modification or revision), when 60% of all participating users have already reached the highest level. In some implementations, correlations between several gamification element and a user attribute are also provided. For example, in some cases, employees who have completed all 100 required training sessions this year, are broken down by their respective office locations and specialty, so as to provide an attribute-by-attribute analysis of user behaviors.

In some implementations, the design adaptation module 146 enables a gamification expert to adapt a (e.g., current or existing) gamification design in accordance with one or more analysis results of gamification data.

In some implementations, A/B Testing with experiment and control groups (A/B test) is used to evaluate the effects of a gamification design change in a particular context, so as to validate the design change.

In some implementations, with A/B testing, effects of gamification design changes are verified before being activated for (e.g., applied to) a predefined user group (e.g., the entire user base).

In some implementations, the design adaptation module 146 enables a gamification expert to conduct experiments and analyze their results, so as to provide gamification analytics. In some implementations, an A/B testing comprises an experiment creation stage and an experiment result analysis stage.

In some implementations, during an experiment creation stage, the design adaptation module 146 creates an experiment based on one or more criteria provided by a gamification expert, e.g., target KPIs, desired KPI impact (increase or decrease), and proposed design changes (which are subject of the experiment). In some implementations, the design adaptation module 146 applies user-selected parameters to an existing gamification design, and enables an experiment by collecting and/or processing gamification-related data (e.g., via the KPI monitoring module 142 and the gamification element analysis module 144) from a gamification (or a gamified enterprise application) in accordance with the modified design. In some implementations, the application data 105 (shown in FIG. 1) are orthogonalized to produce gamification data 103 (also shown in FIG. 1), based on which application KPIs can be calculated.

After collecting a predefined amount of gamification data, in some implementations, the design adaptation module 146 analyzes the differences between gamification data collected from an experiment environment (e.g., with a modified gamification design) and those collected form an control group (e.g., with the original gamification design), thereby enabling a gamification expert to understand the impacts of the design change.

In some implementations, during an experiment result analysis stage, the design adaptation module 146 provides a gamification expert a report (e.g., a summary) of observed or detected effects on user behaviors.

In some implementations, the design adaptation module 146 also determines (e.g., calculates), whether these effects are more than a threshold amount of significance (e.g., statistically significant) compared to the control group.

These techniques are advantageous in that they support informed decision making in the design adaptation process. In some implementations, when a design change is validated (e.g., adopted), the design adaptation module 146 generates one or more annotations in relevant graphical charts, indicating that a design change was conducted. In some implementations, the design adaptation module 146 also archive experiment results for future reference.

In some implementations, the design adaptation module 146, in addition to change gamification design based on A/B testing, enables a gamification expert to directly change a gamification design, which in some cases generates change markers in KPI visualizations. Direct changes might be desirable in cases when A/B testing are not suitable, e.g. with small user groups or when under time constraints.

In some implementations, the user grouping module 148 enables a gamification expert to analyze gamification data and application data, e.g., in accordance with one or more selected user groups of interest.

In some implementations, a user group is selected or identified in accordance with one or more user properties, e.g., work location, work title, and job responsibility. This approach is applicable when the intended criteria are known, e.g., to a gamification expert, before user groups are selected, for instance, testing engineers located in a particular geographical region (e.g., Europe) and who have reached gamification level 9 (e.g., have completed 9 out of the 10 assigned tasks).

In some implementations, a user group is selected or identified in accordance with a clustering analysis, e.g., in order to identify similar user groups from a large number of users. For example, a gamification expert can conduct a cluster analysis on user properties to discover potential user groups. This approach is advantageous, e.g., when exact criteria for selecting user groups are not well defined or known to a gamification expert.

In some implementations, a user group is selected or identified in accordance with one or more manual selections. For example, a gamification expert, analyzing gamification data, can manually compose a user group. This is advantageous in analyzing user groups whose members' behaviors are of special interest and whose members are known a priori. Gamification experts might, for instance, want to compose a user group out of community members with a high reputation.

In some implementations, a user group is selected or identified to provide filtered reviewed of gamification data. For example, a gamification expert, in some cases, can filter an entire set of application data and user behavior data, by selecting a particular user group of interest. In some cases, this technique is provided at all analysis stages, where statistical overviews are shown. Based on one or more filters applied, a gamification expert can selectively review application KPIs, as well as gamification element statistics and simulation results.

In some implementations, the simulation module 150 enables a gamification expert to simulate a gamification design idea with existing user data and behavior data. For example, using historical data regarding policy compliance and rewards distribution, a gamification expert may predict future compliance under a similar rule with increased rewards. These techniques are advantageous: taking advantage of known user behaviors, a simulation can reveal design imperfections or flaws in a new gamification design. In some implementations, simulation results are analyzed in the same way as non-experiment data (e.g., production data) are, by viewing application KPIs, gamification element analytics, and in view of predefined user groups of interest. In some implementations, the simulation module 150 simulates a gamification design by applying different sets of gamification rules to existing behavior data. In some implementations, gamification results can be interpreted to determined how the gamification states would be if the user had interacted with the simulated rules (e.g., with the assumption that user behaviors remain substantially the same). FIG. 2 is an example flow chart illustrating a method 200 for providing gamification analytics in an enterprise environment, in accordance with some implementations.

As shown in FIG. 2, in some implementations, a gamification platform 210 is provided to one or more gamified applications 202, such as an ERP application 202-1, or an enterprise information amendment (EIS) application 202-2.

In some implementations, an application datastore 204 is connected with both the gamification platform 210 and a gamified application 202. In some implementations, the application datastore 204 manages user behavior data 206 (e.g., frequency for code check-ins) and user properties 208 (e.g., work location and work title).

In some implementations, the gamification platform 210 (e.g., via an event dispatcher 212) monitors and gathers enterprise events 211 (e.g., when a vacation request is entered, when a program is checked-into a code repository, and when database table is updated) from the one or more gamified applications 202, and dispatches these events to a data importer 216 and a business rule management system (BRMS) 214.

In some implementations, the gamification platform 210 includes a datastore 218, which manages and stores one or more set of gamification rules 220, gamification data (e.g., gamification data) 222, user behavior data 224, user properties (e.g., user attributes) 226, and user group definitions (e.g., grouping criteria) 228.

In some implementations, the gamification platform 210 includes a gamification analytics module 230, which includes an A/B testing module 232 (e.g., for enabling A/B testing on potential design changes), a KPI monitor 234 (e.g., for monitoring application KPIs), a group filter 236 (e.g., for applying one or more user grouping criteria), a simulation module 238 (e.g., for simulating design changes with historical user behavior data and application data), and a gamification element analytics 240 (e.g., for analyzing gamification state elements).

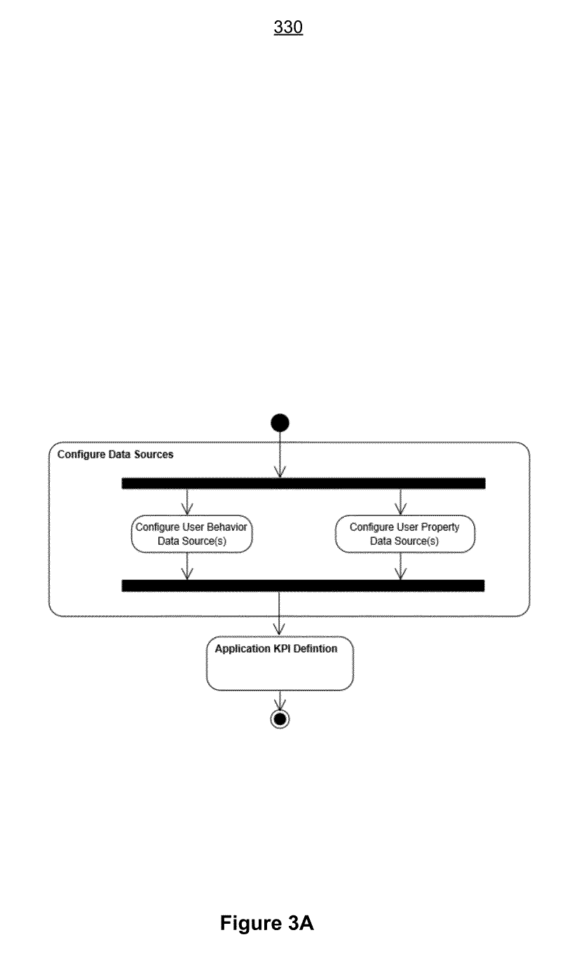

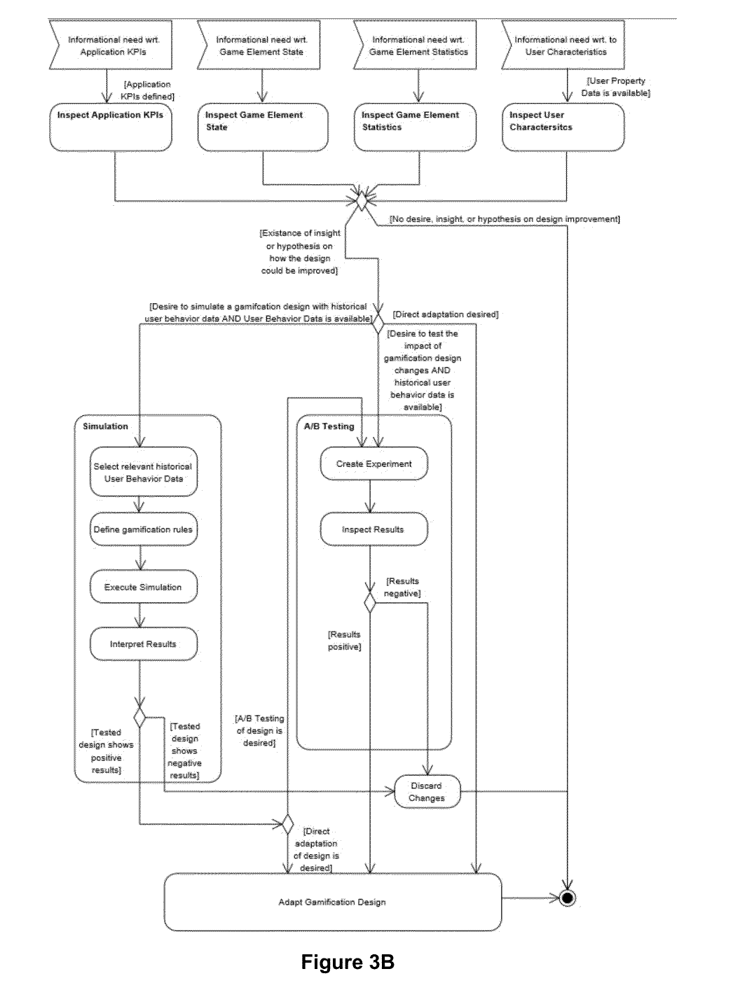

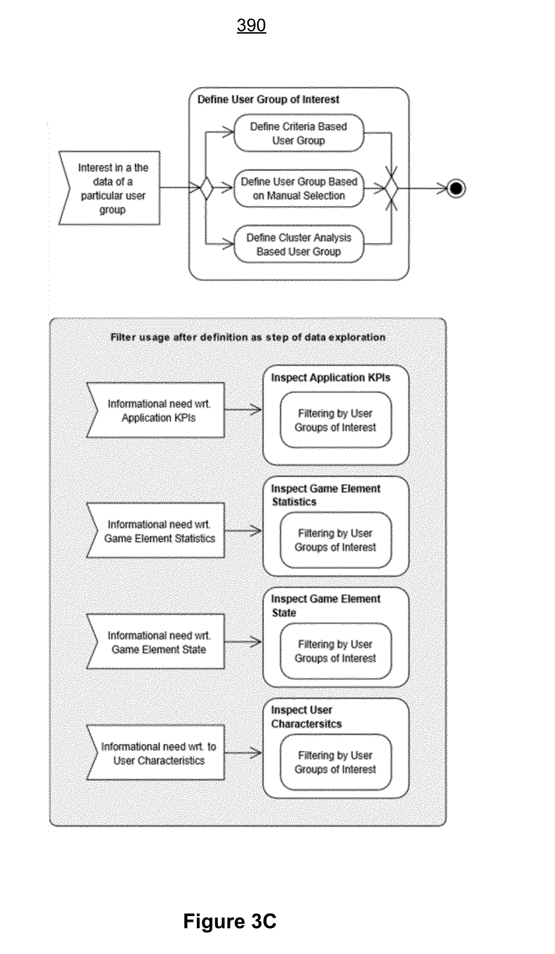

FIG. 3 is an example flow chart illustrating a method 300 for providing gamification analytics in an enterprise environment, in accordance with some implementations.

As shown in FIG. 3, in some implementations, providing gamification analytics in an enterprise environment involves first setting up data sources (302), e.g., designating one or more user or application behavior data sources (e.g., a database log file), or connecting with user properties data sources (e.g., a human resource information management database).

As also shown in FIG. 3, in some implementations, after one or more application KPIs are defined or selected (e.g., by a gamification expert), information representing application KPIs, gamification element states, gamification element statistics, and user characteristics are collected over a predefined time period (e.g., a 3 month trial period).

In some implementations, these data are then analyzed and formatted (e.g., visualized) for analysis by a gamification expert, in order to discover potential gamification design imperfections or flaws.

In some implementations, when data associated with a particular group of users are considered of interest (304), a gamification expert first defines one or more user groups of interest by: (1) defining a criteria based (e.g., age or geographical location) user group; (2) manually selecting a group of users (e.g., a group of key employees); or (3) defining a user group based on cluster analysis. In some implementations, after one or more user groups are defined, gamification data (e.g., application behavior data and user data) are then filtered and analyzed based on these groups.

In some implementations, where a simulation (e.g., pre-incorporation testing) feature is provided, historical gamification data (e.g., historical user behavior data) are used (e.g., reused) to simulate how an enterprise application with a particular gamification design would behave (306). For example, how software engineers react to a proposed policy change (e.g., from providing a free training session for every 50 timely code check-ins to for providing the same for every 150 time check-ins). Enabling gamification simulation is advantage: it can reveal potential imperfections or flaws in a proposed gamification design. In some implementations, simulation results are analyzed in the same way as real data are by viewing application KPIs, gamification element analytics, and in view of predefined user groups of interest.

In some implementations, when simulation results satisfy a predefined set of requirements, a proposed gamification design change is then incorporated into an existing gamification design, thereby improving the existing gamification design.

In some implementations, testing a gamification design change (e.g., post-incorporation testing) feature is also enabled (308). For example, after receiving positive simulation results, a gamification expert incorporates a set of new rules into existing gamification rule. In some implementations, the incorporation of new rules is tested to determine whether it meets the expectations.

In some implementations, as disclosed herein, an A/B testing is applied to a gamification design change, in order to fathom its impacts on a gamified enterprise application. If a gamification design change produces positive results, the design change is validated or adapted into the current design. If a gamification design change produces less than positive (e.g., negative) results, the design change is discarded and not incorporated into the current design.

FIG. 3A shows activities relating to activity setup. This diagram covers the setup phase. It comprises setting up the necessary data sources and defining the relevant application KPIs (which are calculated on basis of these data).

FIG. 3B shows activities relating to analysis. This diagram captures the actual analysis and following adaptation efforts. It always starts with data exploration intent which can then lead to some idea how the design could be improved. This idea is then evaluated (simulation and/or A/B Testing) and depending on results either applied or discarded. It is noteworthy that the whole process is of course iterative. Once you arrived at the end of one instance, you will logically start a new instance of it by doing data exploration activities:

FIG. 3C shows activities relating to activity filtering. In the upper part this diagram describes the definition of filters. In the lower part it details how they are applied as an optional step in data exploration.

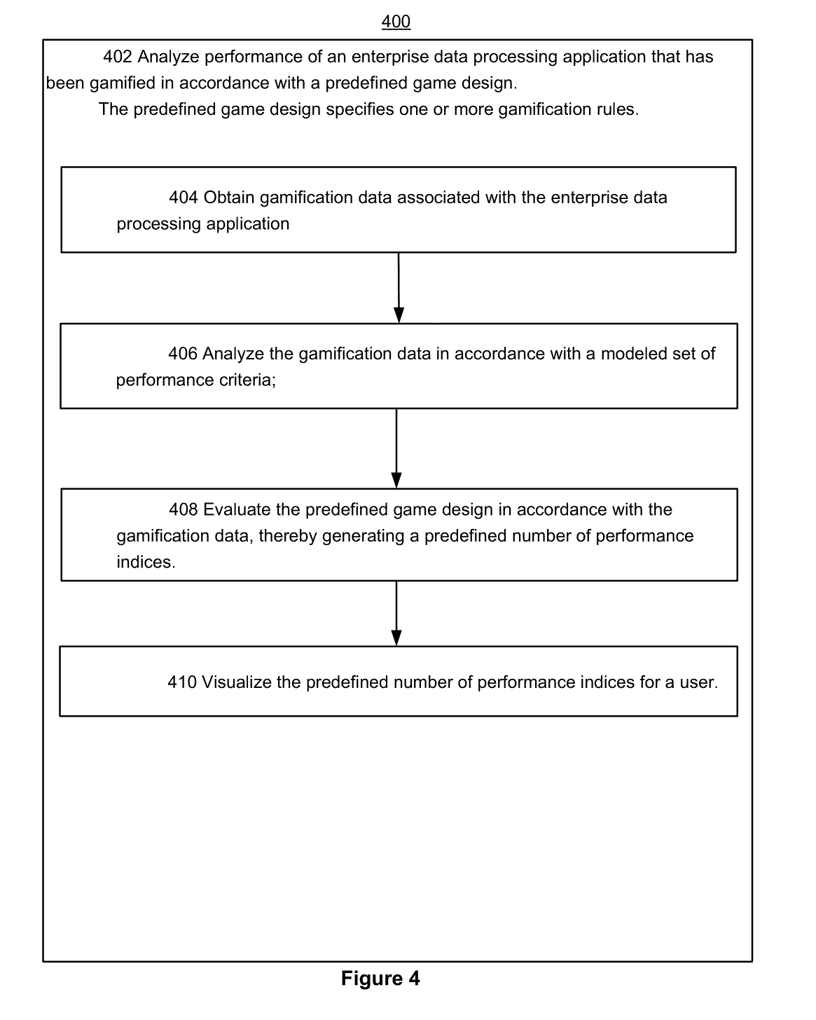

FIG. 4 is an example flow chart illustrating a method 400 for providing gamification analytics in an enterprise environment, in accordance with some implementations.

In some implementations, the method 400 is implemented at a computing device (e.g., the analytics system 108) having one or more processors and memory storing one or more programs for execution by the one or more processors.

In some implementations, the method 400 includes analyzing (402) performance of an enterprise data processing application (e.g., an ERP application) that has been gamified in accordance with a predefined gamification design. In some implementations, the predefined gamification design specifies one or more gamification rules, e.g., when an employee timely enters his/her time sheets in accordance with a corporate HR policy, the employee is awarded a badge called the “employee of the month”; and whoever answers three help questions from an end-user in an online community receives a free online course. In some implementations, the gamification platform is external to (e.g., independent from) the gamified enterprise application.

In some implementations, the method 400 includes obtaining (404) gamification data associated with the enterprise data processing application. For example, in some case, gamification data 222, user behavior data 224 (e.g., how frequently a data entry specialist synchronizes his/her entries with a corporate database), and user properties 226 (e.g., an employee's work location and preferred language) are collected, periodically or randomly, by the gamification platform 210. In some implementations, these gamification data (or a portion thereof) are analyzed to provide gamification analytics for review by a user (e.g., a gamification expert).

In some implementations, the method 400 includes analyzing (406) the gamification data in accordance with a modeled set of performance criteria.

In some implementations, the method 400 includes evaluating (408) the predefined gamification design in accordance with the gamification data, thereby generating a predefined number of performance indices.

In some implementations, the method 400 also includes visualizing (410) the predefined number of performance indices for a user.

In some implementations, the gamification data include one of: application KPIs (e.g., user-defined or otherwise), application data, user behavior data, and user attributes (e.g., job title, work schedule, and compensation package).

In some implementations, visualizing the predefined number of performance indices for the user includes: causing the application KPIs to be displayed in accordance with one or more time criteria using a dashboard view. For example, KPIs (such as profile completion rate, ratio of correct answered questions, ration of at least helpful answered questions, and new blog posts per user and month), are in some cases, displayed with a set of user-selectable time filters (such as weekend, month, and year). In these ways, key KPIs can be analyzed over predefined time periods, which may correspond to several particular enterprise operation periods (e.g., summer vacation quarter, Christmas time, and spring months).

In some implementations, visualizing the predefined number of performance indices for the user includes: annotating KPI curves with a marker to indicate a past change to the predefined gamification design.

In some implementations, the application KPIs include one of: user-customized KPIs, and pattern based KPIs.

In some implementations, visualizing the predefined number of performance indices for the user includes: causing to be concurrently displayed (A) a KPI goal value, and (B) a corresponding actual KPI value. For example, as shown in FIG. 5, “New blog Post per User and Month” is displayed in view of a goal value (“0.70”) so as to assist a user to visualize application performance in view of (e.g., experiment) goals.

In some implementations, the gamification date includes one or more sets of gamification state data, e.g., gamification levels and corresponding user distributions, missions and corresponding user distributions.

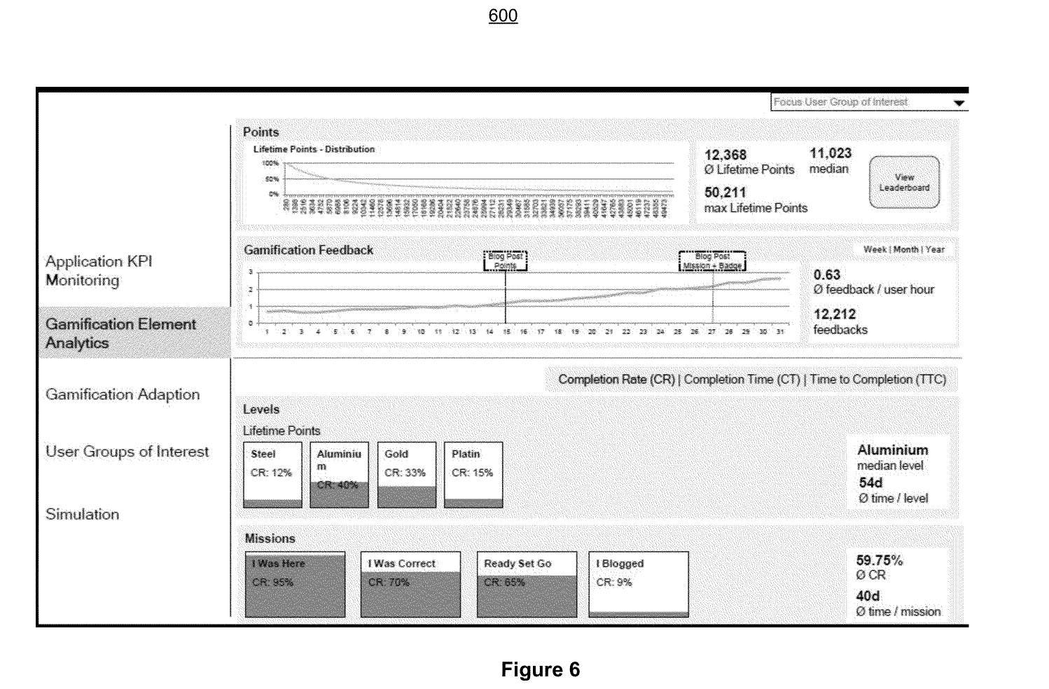

In some implementations, the one or more sets of gamification state data include one of: user feedback data, point distributions, achievable gamification elements, user distributions, temporal statistics, and user characteristics, as shown in FIG. 6.

In some implementations, analyzing the gamification data in accordance with the modeled set of performance criteria includes: calculating points distribution among a set of user to detect candidate problems in the predefined gamification design. For example, if the majority of a group of users have received less than 20% of the totally points so far distributed, a gamification expert may choose to revise a gamification rule to modify the current gamification design, e.g., so as to encourage further user participation.

In some implementations, analyzing the gamification data in accordance with the modeled set of performance criteria includes: calculating user feedback rate in accordance with user feedback data.

In some implementations, analyzing the gamification data in accordance with the modeled set of performance criteria includes: identifying achievable gamification elements specified in the predefined gamification design.

In some implementations, visualizing the predefined number of performance indices for the user includes: causing to be displayed, responsive to a predefined user action, user distribution information in accordance with a selected state of a particular gamification state element.

In some implementations, visualizing the predefined number of performance indices for the user includes: causing to be displayed, responsive to a predefined user action, temporal statistics associated with a particular gamification state element.

In some implementations, visualizing the temporal statistics includes one of: time to completion, time to assignment, and time active.

In some implementations, visualizing the predefined number of performance indices for the user includes: identifying a user property associated with a predefined number of users having a same state on a gamification element.

In some implementations, the method also includes: modifying the predefined gamification design in accordance with a user-identified performance index in the predefined number of performance indices.

In some implementations, modifying the predefined gamification design in accordance with the user-identified performance index includes: (A) enabling an experiment session with a modification to the predefined gamification design, and (B) modifying the predefined gamification design responsive to a determination that the modification changes performance of the enterprise data processing application in a predefined manner.

In some implementations, modifying the predefined gamification design in accordance with the user-identified performance index includes: modifying a gamification rule in the one or more gamification rules in accordance with a user input.

FIG. 5 is a screen image illustrating an example user interface 500 for providing gamification analytics in an enterprise environment, in accordance with some implementations.

As shown in FIG. 5, in some cases, one or more application KPIs are monitored and benchmarked over predefined time periods, and shown as above a predefined goal value (e.g., meeting or exceeding exportation) or below the predefined goal value (e.g., failing expectation). These techniques are advantageous, as they enable a gamification expert to view important gamification data in accordance with time periods that may be of interest (e.g., 6 months within a new hire starts, 3 months after an employee resigns, and 1 year after a key gamification design change is implemented).

FIG. 6 is a screen image illustrating an example user interface 600 for providing gamification analytics in an enterprise environment, in accordance with some implementations.

As shown in FIG. 6, in some cases, gamification element analytics is provided and benchmarked. In some implementations, the gamification element analytics includes gamification state overview, such as point distribution and gamification level distributions for a group of users. This is advantageous, as an imbalanced point distribution for gamified actions can reveal potential gamification design defects or flaws.

As shown in FIG. 6, in some cases, gamification feedback rate (which may be indicative of user participation or lack thereof) is provided, as is point distribution over predefined gamification levels or mission stages.

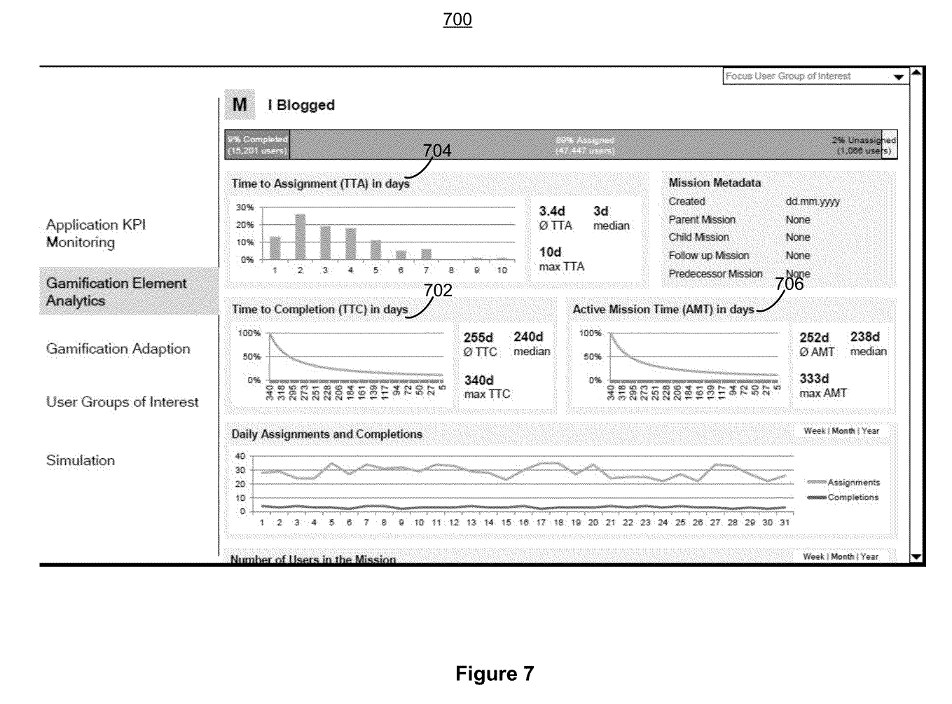

FIG. 7 is a screen image illustrating an example user interface 700 for providing gamification analytics in an enterprise environment, in accordance with some implementations.

As shown in FIG. 7, in some cases, statistics of achievable gamification elements (e.g., badges, levels, missions, and rewards) is provided and benchmarked. For example, a temporal statistics of various gamification elements is provided, e.g., how long a user needed to complete a particular gamification element. In some implementations, the statistics of achievable gamification elements includes: (1) time to completion (702), e.g., the time period between a user begins a gamification element and its completion; (2) time to assignment (704), e.g., the time period between a user joins a gamification (or a gamified enterprise application) and the user is assigned a gamification element (e.g., a task); (3) time active (706), e.g., the time period between a task assignment and the completion thereof. These techniques are advantageous as they enable a gamification expert to view gamification data and application data from a particular perspective.

In some implementation, information representing user interactions with a gamification element (e.g., a leader board) is recorded and provided for future analysis. For example, a log file, a screenshot, an audio clip, or an video clip for reconstructing or understanding how a user comes to the leader board, how long the user spent viewing the board and one or more actions the user took after leaving the board are recorded in a video file, and later provided to a gamification expert for analysis.

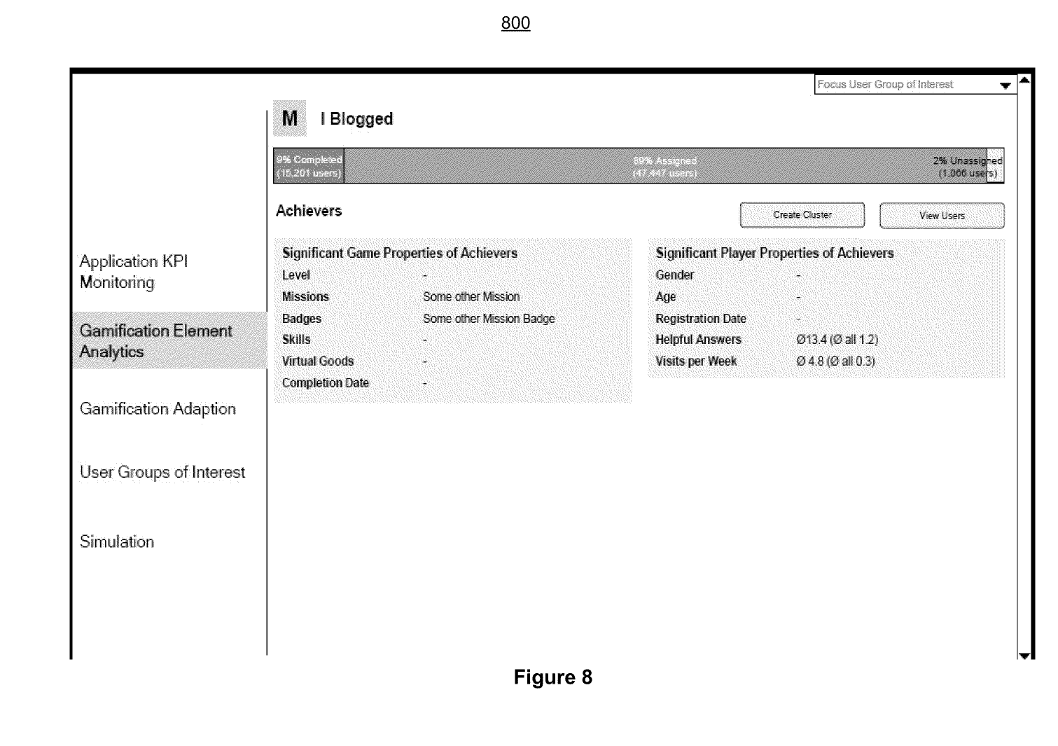

FIG. 8 is a screen image illustrating an example user interface 800 for providing gamification analytics in an enterprise environment, in accordance with some implementations.

As shown in FIG. 8, in some cases, statistics of (e.g., statistically significant) user characteristics (e.g., user attributes) is provided and benchmarked. For example, one or more user properties associated with user who have complete all gamification levels are identified for a gamification expert, who can then determine whether any of these properties have a causal relationship with the fact that these user were able to complete all gamification levels. For example, after 3 months, all software engineers (property 1) located in Germany (property 2) have accomplished all tasks assigned; a gamification expert, using these data, can then further determine whether being a software engineer (property 1) or being located in Germany (property 2), or both, have a statistically important impact on their completion of all tasks. The gamification expert can then using these conclusions to improve existing gamification designs. By these ways, critical user properties can be discovered and used to improve a gamification system.

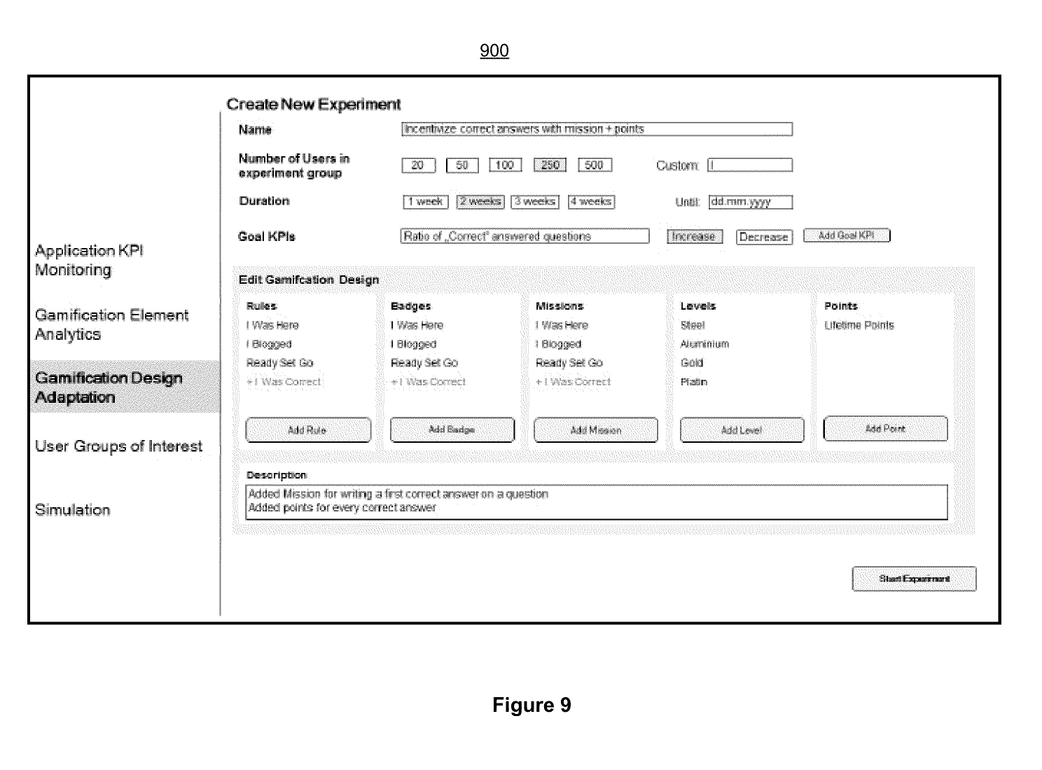

FIG. 9 is a screen image illustrating an example user interface 900 for providing gamification analytics in an enterprise environment, in accordance with some implementations.

As shown in FIG. 9, in some cases, functionalities for creating an experiment, a simulation, or an A/B test are provided. For example, when creating a new experiment, a gamification expert is enabled to designate the number of users involves, experiment duration, goal KPIs and modifications to gamification designs. After an experiment is configured, it can be conducted with historical data (e.g., a simulation) or in a production environment (e.g., a trial).

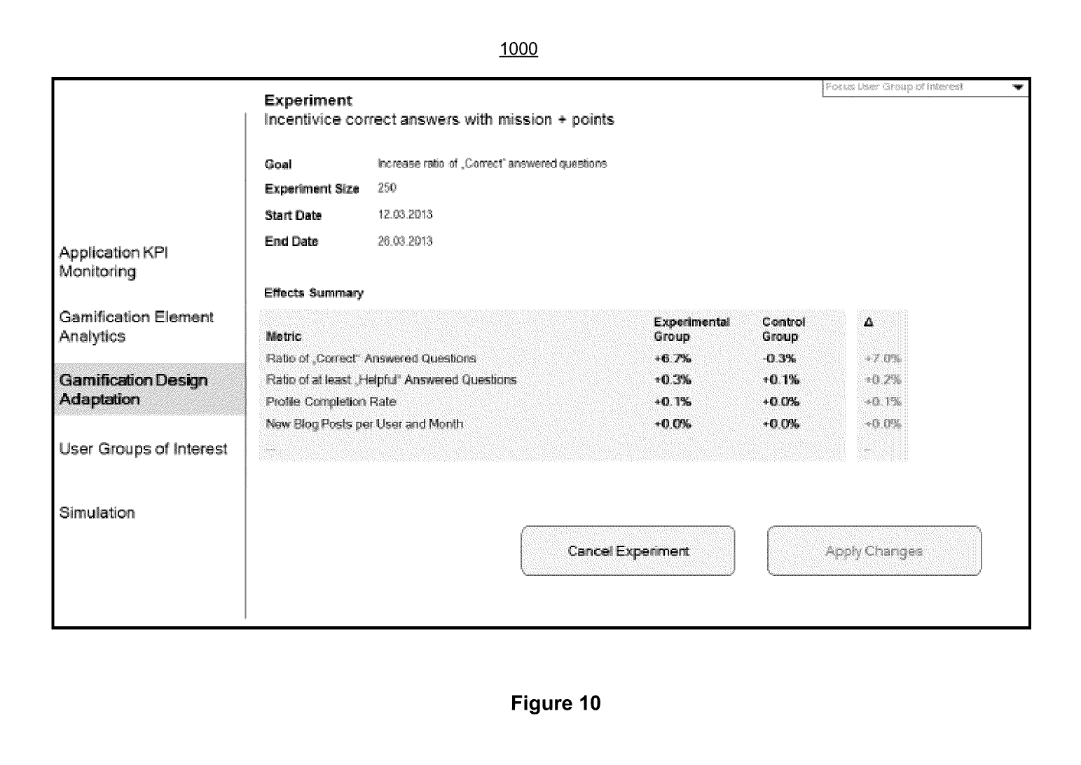

FIG. 10 is a screen image illustrating an example user interface 1000 for providing gamification analytics in an enterprise environment, in accordance with some implementations.

As shown in FIG. 10, in some cases, after conducting an experiment, the analytics system 108 experiment results (e.g., A/B test results). In some cases, result benchmarks from an experimental group are compared with those from a control group, and delta is provided. Bases on these experiment results, a gamification expert may decide, e.g., whether to continue the experiment, to cancel the experiment, or to apply a proposed gamification design to an existing game.

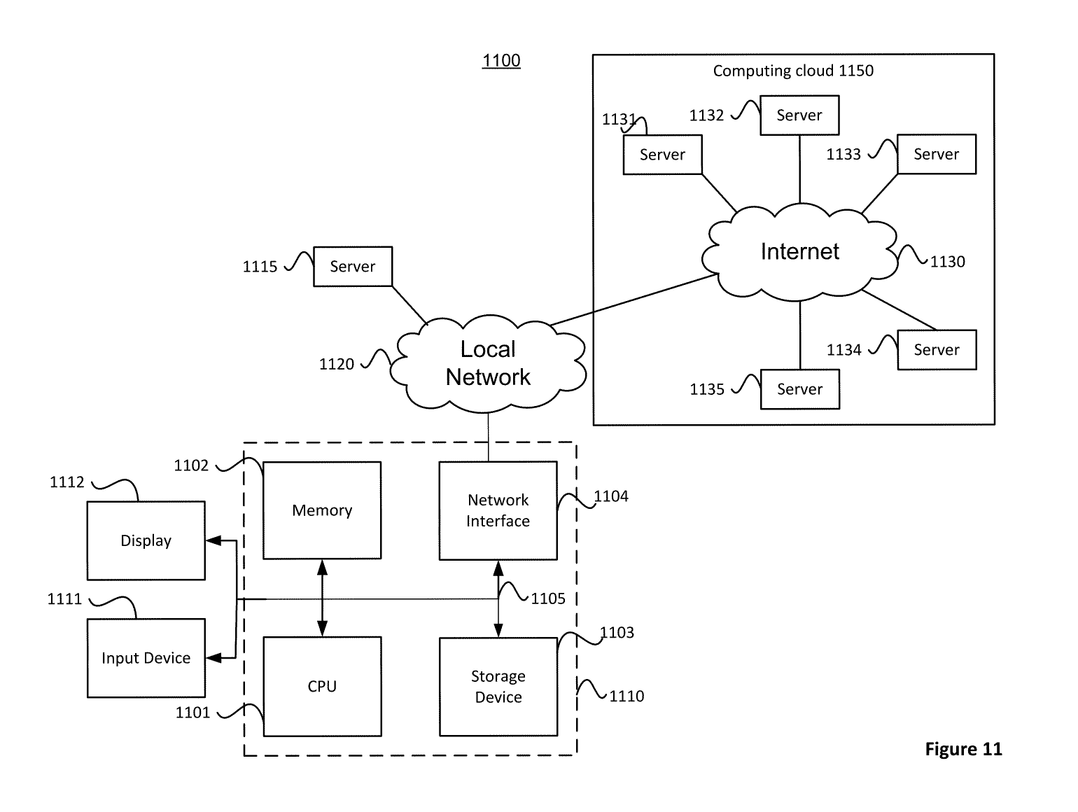

FIG. 11 is an example block diagram illustrating an example computing system for providing gamification analytics in an enterprise environment, in accordance with some implementations.

As shown in FIG. 11, in some implementations, the computing system 1110 includes a bus 1105 or other communication mechanism for communicating information, and a processor 1101 coupled with the bus 1105 for processing information. In some implementations, the computing system 1110 also includes a memory 1102 coupled to bus 1105 for storing information and instructions to be executed by processor 1101, including information and instructions for performing the techniques described above, for example. In some implementations, the memory 1102 may also be used for storing variables or other intermediate information during execution of instructions to be executed by processor 1101. In some implementations, the memory 1102 includes, but is not limited to, random access memory (RAM), read only memory (ROM), or both. A storage device 1103 is also provided for storing information and instructions. Common forms of storage devices include, for example, a hard drive, a magnetic disk, an optical disk, a CD-ROM, a DVD, a flash memory, a USB memory card, or any other medium from which a computing system can obtain information. In some implementations, the storage device 1103 may include source code, binary code, or software files for performing the techniques above, for example. The storage device 1103 and the memory 1102 are both examples of computer readable mediums.

In some implementations, the computing system 1110 may be coupled via the bus 1105 to a display 1112, such as a cathode ray tube (CRT) or liquid crystal display (LCD), for displaying information to a user. An input device 1111 such as a keyboard and/or mouse is coupled to the bus 1105 for communicating information and command selections from the user to the processor 1101. The combination of these components allows the user to communicate with the computing system 1110. In some systems, the bus 1105 may be divided into multiple specialized buses.

In some implementations, the computing system 1110 includes a network interface 1104 coupled with the bus 1105. In some implementations, the network interface 1104 provides two-way data communications between the computing system 1110 and the local network 1120. In some implementations, the network interface 1104 includes a digital subscriber line (DSL) or a modem to provide data communication connection over a telephone line, for example. Another example of the network interface 1104 is a local area network (LAN) card to provide a data communication connection to a compatible LAN. Wireless links are another example. In any such implementation, the network interface 1104 sends and receives electrical, electromagnetic, or optical signals that carry digital data streams representing various types of information.

In some implementations, the computing system 1110 sends and receives information, including messages or other interface actions, through the network interface 1104 across a local network 1120, an Intranet, or the Internet 1130. In some implementations, the local network, the computing system 1110 communicates with a plurality of other computer machines, such as a server 1115 or a computing cloud 1150. In some implementations, the computing system 1110 and server computer systems represented by the server 1115 form a cloud computing network, which may be programmed with processes described herein. In the Internet example, software components or services may reside on multiple different computing systems 1110 or servers 1131-1135 across the network. In some implementations, the processes described above are implemented at computing cloud 1150, which includes one or more servers from the servers 1131-1135. In some implementations, the server 1131 transmits actions or messages from one component, through the Internet 1130, the local network 1120, and the network interface 1104 to a component of the computing system 1110. In some implementations, the software components and processes described above are implemented on any computer system and send and/or receive information across a network.

This application incorporates by reference the following U.S. patent application Ser. No. 13/586,507, Ser. No. 13/649,916, and Ser. No. 14/276,679, in their entireties.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first set could be termed a second set, and, similarly, a second set could be termed a first set, without changing the meaning of the description, so long as all occurrences of the “first set” are renamed consistently and all occurrences of the “second set” are renamed consistently. The first set and the second set are both sets, but they are not the set.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method comprising:
at a computing device having one or more processors and memory storing one or more programs for execution by the one or more processors:
analyzing performance of an enterprise data processing application that has been gamified in accordance with a predefined gamification design, wherein the predefined gamification design specifies one or more gamification rules, by:
obtaining gamification data associated with the enterprise data processing application;
analyzing the gamification data in accordance with a modeled set of performance criteria;
evaluating the predefined gamification design in accordance with the gamification data, thereby generating a predefined number of performance indices; and
visualizing the predefined number of performance indices for a user.

2. The method of claim 1, wherein the gamification date include one of: application KPIs, application data, user behavior data, and user attributes.

3. The method of claim 2, wherein visualizing the predefined number of performance indices for the user includes: causing the application KPIs to be displayed in accordance with one or more time criteria using a dashboard view.

4. The method of claim 2, wherein visualizing the predefined number of performance indices for the user includes: annotating KPI curves with a marker to indicate a past change to the predefined gamification design.

5. The method of claim 2, wherein the application KPIs include one of: user-customized KPIs, pattern based KPIs, and KPI goal values.

6. The method of claim 5, wherein visualizing the predefined number of performance indices for the user includes: causing to be concurrently displayed (A) a KPI goal value, and (B) a corresponding actual KPI value.

7. The method of claim 1, wherein the gamification data include one or more sets of gamification state data.

8. The method of claim 1, wherein the one or more sets of gamification state data include one of: user feedback data, point distribution, achievable gamification element, user distribution, temporal statistics, and user characteristics.

9. The method of claim 8, wherein analyzing the gamification data in accordance with the modeled set of performance criteria includes: calculating points distribution among a set of user to detect candidate problems in the predefined gamification design.

10. The method of claim 8, wherein analyzing the gamification data in accordance with the modeled set of performance criteria includes: calculating user feedback rate in accordance with user feedback data.

11. The method of claim 8, wherein analyzing the gamification data in accordance with the modeled set of performance criteria includes: identifying achievable gamification elements specified in the predefined gamification design.

12. The method of claim 1, wherein visualizing the predefined number of performance indices for the user includes: causing to be displayed, responsive to a predefined user action, user distribution information in accordance with a selected state of a particular gamification state element.

13. The method of claim 1, wherein visualizing the predefined number of performance indices for the user includes: causing to be displayed, responsive to a predefined user action, temporal statistics associated with a particular gamification state element.

14. The method of claim 13, wherein visualizing the temporal statistics include one of: time to completion, time to assignment, and time active.

15. The method of claim 1, wherein visualizing the predefined number of performance indices for the user includes: identifying a user property associated with a predefined number of users having a same state on a gamification element.

16. The method of claim 1, further comprising: modifying the predefined gamification design in accordance with a user-identified performance index in the predefined number of performance indices.

17. The method of claim 16, wherein modifying the predefined gamification design in accordance with the user-identified performance index includes: (A) enabling an experiment session with a modification to the predefined gamification design, and (B) modifying the predefined gamification design responsive to a determination that the modification changes performance of the enterprise data processing application in a predefined manner.

18. The method of claim 16, wherein modifying the predefined gamification design in accordance with the user-identified performance index includes: modifying a gamification rule in the one or more gamification rules in accordance with a user input.

19. A non-transitory computer readable storage medium storing one or more programs, the one or more programs comprising instructions, which when executed by a computing system with one or more processors, cause the computing system to execute a method of:
analyzing performance of an enterprise data processing application that has been gamified in accordance with a predefined gamification design, wherein the predefined gamification design specifies one or more gamification rules, by:
obtaining gamification data associated with the enterprise data processing application;
analyzing the gamification data in accordance with a modeled set of performance criteria;
evaluating the predefined gamification design in accordance with the gamification data, thereby generating a predefined number of performance indices; and
visualizing the predefined number of performance indices for a user.

20. A computing system, comprising:
one or more processors;
memory; and
one or more programs, wherein the one or more programs are stored in the memory and configured to be executed by the one or more processors, the one or more programs including instructions for:
analyzing performance of an enterprise data processing application that has been gamified in accordance with a predefined gamification design, wherein the predefined gamification design specifies one or more gamification rules, by:
obtaining gamification data associated with the enterprise data processing application;
analyzing the gamification data in accordance with a modeled set of performance criteria;
evaluating the predefined gamification design in accordance with the gamification data, thereby generating a predefined number of performance indices; and
visualizing the predefined number of performance indices for a user.
